(19) United States
(12) Patent Application Publication
(10) Pub. No.: US 2026/0346706 A1
(43) Pub. Date: Nov. 5, 2026

(54) CHASSIS FOR A VEHICLE, COMPRISING A TANK

(71) Applicant: AMPERE S.A.S., Boulogne Billancourt (FR)

(72) Inventors: Panagiotis CHRISTOU, Guyancourt (FR); Jérémi GOBRECHT, Guyancourt (FR); Laurent GRENIER, Guyancourt (FR); Kamel MOUSSI, Guyancourt (FR)

(73) Assignee: AMPERE S.A.S., Boulogne Billancourt (FR)

(21) Appl. No.: 19/141,802

(22) PCT Filed: Dec. 19, 2023
(86) PCT No.: PCT/EP2023/086638

§ 371 Date: Jun. 20, 2025

(30) Foreign Application Priority Data
Dec. 21, 2022 (FR) FR2214040

(51) Int. Cl. B60K 15/07; B60K 15/03; B60K 15/063; B60K 15/073; B60N 2/005; B60R 22/22

(52) U.S. Cl. CPC B60K 15/07; B60K 15/073; B60N 2/005; B60R 22/22; B60K 2015/03315; B60K 2015/0631; B60K 2015/0638

(57) ABSTRACT

A chassis for a vehicle includes a first longitudinal member, a second longitudinal member, and a tank intended to store an energy fluid. The longitudinal members extend parallel to a longitudinal axis. The tank is arranged in an extension of the longitudinal members along the longitudinal axis and attached to the longitudinal members. The tank is intended to support a load exerted by at least one piece of equipment in the vehicle and/or by body parts of the vehicle

### TECHNICAL FIELD OF THE INVENTION

The invention relates to a chassis for a vehicle, comprising a tank intended to store an energetic fluid, notably hydrogen. The invention also relates to an arrangement for a vehicle, comprising such a chassis. The invention also relates to a vehicle, notably a motor vehicle, comprising such a chassis and/or such an arrangement.

### Prior Art

In order to make the use of vehicles less polluting, vehicles equipped with a fuel cell that is supplied with energy by hydrogen are known. These vehicles therefore have a tank on board in which hydrogen is stored before being consumed by the fuel cell. The pressure of the hydrogen in these tanks can be very high, for example of the order of 700 bar. The tanks therefore have to be particularly resistant to the mechanical stresses exerted by the pressurized hydrogen. In addition, hydrogen is a highly flammable gas which causes risks of fire in the event of a leak. Hydrogen tanks therefore also have to be impact-resistant, so as to ensure the safety of passengers in the event of an accident involving the vehicle.

The tanks known from the prior art generally take the form of one or more cylinders on board the vehicle, for example cylinders positioned under vehicle seats. These tanks are very heavy. Not only do the tanks increase the total weight of the vehicle, but they also require a reinforced chassis to retain them. The chassis is therefore also larger, which runs counter to the objective of providing a more energy-efficient vehicle. In addition, the tanks are also very voluminous and their integration in a vehicle adversely affects the volume available for the passengers or for stowing objects. In particular when the tanks are positioned under the seats of vehicles, the squab of these seats may be raised, impairing the habitability of the vehicle. Lastly, these tanks are also difficult to fasten reliably and stably within the vehicle.

### Presentation of the Invention

The aim of the invention is to provide a chassis for a vehicle that overcomes the above drawbacks and improves the chassis known from the prior art.

More specifically, a primary object of the invention is to provide a vehicle equipped with a tank which is intended to store an energetic fluid such as hydrogen, is relatively lightweight, simple to assemble and makes it possible to preserve a relatively large volume for passengers or for stowage.

### SUMMARY OF THE INVENTION

The invention relates to a chassis for a vehicle, comprising a first side member, a second side member and a tank intended to store an energetic fluid, the side members extending parallel to a longitudinal axis, the tank being arranged in a continuation of the side members along the longitudinal axis and fastened to the side members, the tank being intended to withstand a load exerted by at least one item of equipment on board the vehicle and/or by body elements of the vehicle.

The side members may be fastened respectively against two opposite lateral walls of the tank.

The tank may comprise an upper wall provided with a recess intended to receive the squab of at least one seat.

The tank may comprise an anti-submarining device configured to prevent a squab of a seat from sliding forward in the event of an accident.

The invention also relates to an arrangement for a vehicle, comprising a chassis as defined above, the arrangement further comprising at least one item of equipment and/or body elements supported by the tank and fastened to the tank.

The arrangement may comprise at least one item of equipment supported by the tank and fastened to the tank, the at least one item of equipment comprising at least one seat and/or a safety device intended to safeguard a passenger in the event of an accident.

The arrangement may comprise:
an anchoring means for a seat belt, fastened to an upper wall of the tank, and/or
an anchoring means according to standard ISO 13216-1:1999 fastened to an upper wall of the tank.

The tank may comprise an upper wall provided with a recess intended to receive the squab of at least one seat, and:
the fastened anchoring means for a seat belt may be fastened to a bottom of the recess, and/or
the anchoring means according to standard ISO 13216-1:1999 may comprise a hoop extending horizontally in line with the recess.

The arrangement may comprise body elements supported by the tank and fastened to a rear half of the tank, the side members being fastened to a front half of the tank.

The invention also relates to a vehicle, notably a motor vehicle, comprising a chassis as defined above and/or an arrangement as defined above.

### PRESENTATION OF THE FIGURES

These subjects, features and advantages of the present invention will be set out in detail in the following description of one particular embodiment, which description is given by way of non-limiting example with reference to the appended figures, among which:

FIG. 1 is a schematic profile view of a motor vehicle according to one embodiment of the invention.

FIG. 2 is a partial, perspective view from above of a chassis of the vehicle.

FIG. 3 is a side view of a tank of the vehicle, items of equipment being fastened to an upper wall of the tank.

FIG. 4 is a view from above of the tank in FIG. 3.

FIG. 5 is a partial, perspective view from below of the chassis of the vehicle.

FIG. 6 is a perspective view from below of the tank, the tank being provided with a protective casing.

FIG. 7 is a view in longitudinal and vertical section of the tank.

FIG. 8A is a partial, perspective view of one embodiment of a tank of the vehicle.

FIG. 8B is a view in transparency of the tank in FIG. 8A.

FIG. 9 is a view in section of a fastening interface of the tank according to a first embodiment.

FIG. 10 is a view in section of a fastening interface of the tank according to a second embodiment.

### DETAILED DESCRIPTION

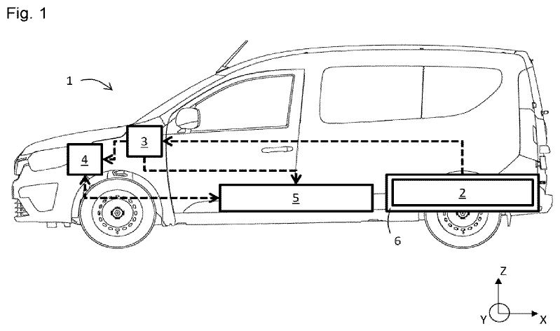

FIG. 1 schematically illustrates a motor vehicle 1 according to one embodiment of the invention. The vehicle 1 may be, for example, a private vehicle or a utility vehicle. As a variant, it could be a truck, a bus, a lifting machine, an agricultural machine or even any other type of land vehicle. The invention may also be adapted to an aircraft or to a ship.

In this document, the axis X denotes the longitudinal axis of the vehicle 1. During forward travel and in a straight line, the vehicle 1 progresses from the rear toward the front in a direction parallel to its longitudinal axis. The axis X is oriented from the front to the rear of the vehicle, that is to say in the direction of reverse travel. The axis Y denotes the transverse axis of the vehicle. The axis Y is oriented from left to right, left and right being defined from the perspective of a driver of the vehicle 1. The axis Z denotes the axis perpendicular to the axis X and the axis Y. The vehicle 1 is considered to be resting on horizontal ground. The axis Z is a vertical axis oriented from the bottom upward. The axes X, Y and Z form an orthogonal frame of reference. This frame of reference defined in relation to the vehicle 1 will be able to be used to describe a tank 2 of the vehicle 1, even considered outside the vehicle, since the tank is intended to be integrated in the vehicle according to a particular orientation.

The vehicle 1 is equipped with a tank 2 according to one embodiment of the invention. The tank 2 is intended to contain an energetic fluid, that is to say a fluid forming a reserve of energy that can be converted into an electromotive force capable of moving the vehicle. The tank 2 is therefore a member of the vehicle 1 that provides it with a certain autonomy. The tank notably comprises an inlet opening for filling the tank with an energetic fluid and an outlet opening for delivering then consuming the energetic fluid contained in the tank.

According to a preferred embodiment, the tank 2 is intended to store hydrogen, or more specifically dihydrogen. The vehicle 1 comprises a fuel cell 3 capable of transforming hydrogen into an electrical current and an electric motor 4 supplied with energy by an electrical current from the fuel cell 3. The vehicle 1 may also comprise an electrochemical battery 5, for example of the lithium-ion type. The electrochemical battery 5 may be recharged by an electrical current from the fuel cell 3 and/or by a connection to an electricity distribution network. The electric motor 4 may also be supplied with energy by an electrical current from the electrochemical battery 5. The tank 2 associated with the fuel cell 3 may thus act as an autonomy extender for the vehicle, when the electrochemical battery 5 has been discharged.

As a variant, the architecture of the vehicle 1 could be different. The vehicle 1 could not comprise an electrochemical battery, such that the tank 2 constitutes the sole source of energy for the vehicle 1. According to another variant, the vehicle could comprise an internal combustion engine supplied with energy by hydrogen instead of a fuel cell. According to other variants, the tank 2 could be configured to store other forms of energetic gases, for example liquefied petroleum gas or natural gas. The tank could even be intended to store a liquid fuel such as gasoline, diesel or ethanol.

The tank 2, which could also be called “storage device”, is intended to store a pressurized energetic fluid, that is to say at a pressure strictly greater than atmospheric pressure. In this case, the tank 2 is intended to store the energetic fluid, notably hydrogen, at a pressure greater than or equal to 700 bar. As a variant, the tank 2 could be intended to store the energetic fluid at a different pressure, for example a pressure greater than or equal to 300 bar, or 500 bar, or 1000 bar, or any other value. The tank 2 thus comprises a rigid structure 6 capable of withstanding the forces exerted by the pressurized fluid it contains, that is to say centrifugal forces acting from the inside of the tank 2 and tending to cause it to burst.

Furthermore, the tank may have a capacity greater than or equal to 50 liters, preferably greater than or equal to 100 liters, or even greater than or equal to 150 liters. A 100-liter tank makes it possible to store approximately 4 kg of hydrogen at 700 bar, providing an autonomy of the order of 300 km to a motor vehicle.

The structure 6 of the tank is also capable of withstanding significant impacts, notably impacts produced in the event of an accident involving the vehicle 1, without generating leakage of energetic fluid to the outside. Accidentology and/or simulation and/or crash test data make it possible to dimension the structure 6, notably thicknesses of required walls, in such a way that no leakage of energetic fluid is produced, even for the most severe accidents.

According to the invention, the tank 2, the high strength of which is necessary for withstanding high pressures of the energetic fluid it contains and for ensuring the safety of passengers in the vehicle 1 in the event of an accident, is advantageously utilized to form a structural element of the vehicle. A structural element denotes a vehicle element that contributes to the overall rigidity of the vehicle. In other words, the tank 2 forms a part of the bodywork of the vehicle, that is to say a part of the framework of the vehicle. In particular, the tank 2 forms a part of the chassis of the vehicle, that is to say a part of the vehicle capable of supporting the weight exerted by other items of equipment of the vehicle, such as the weight exerted by a part at least of the body of the vehicle. In addition, not only does the tank support the weight of certain items of equipment, but it also provides a support for fastening these items of equipment.

In particular, the bodywork of the vehicle 1 would not have sufficient rigidity if it were not equipped with the tank 2. That is to say that the bodywork of the vehicle 1 without the tank 2 would deform easily, notably under the weight alone of the items of equipment on board the vehicle or in the event of a collision involving the vehicle 1, even at very low speed. The tank 2 therefore constitutes an element of the bodywork of the vehicle 1 that is essential to its rigidity and its robustness. The integration of the tank 2 in the bodywork therefore makes it possible to considerably reduce the quantity of material used to produce the vehicle. By virtue of the invention, it is possible to reduce the size of, or even eliminate, certain metallic elements that are traditionally used for designing the bodywork and notably the chassis of a vehicle.

The invention is therefore particularly innovative in that the tank 2, which was conventionally supported by the bodywork, becomes a constituent element. Additionally, the invention runs counter to the widespread belief that a tank should be heavily protected due to the inflammable or explosive character of the energetic fluid it contains. According to this widespread belief, in the normal use condition, the tank should not bear any stress other than that exerted by the energetic fluid it contains.

According to the invention, the tank is capable of withstanding loads which can reach at least one hundred kilograms, or even several hundred kilograms. These loads may be static loads such as those exerted by the weight of the body of the vehicle, and/or the weight of equipment such as seats of the vehicle and/or the weight of passengers in the vehicle. These loads may also be dynamic loads such as those which occur in particular situations such as in the case of an impact against the vehicle. These different static or dynamic loads may exert compressive or shear forces on the tank. These forces are therefore oriented in a different direction to the centrifugal forces exerted by the pressurized energetic fluid inside the tank. Advantageously, the strength of the tank necessary for withstanding the pressure exerted by the energetic fluid it contains is therefore also used to withstand loads exerted in different directions.

The items of equipment of the vehicle which may be supported by the tank 2 and fastened to the tank notably include:
items of equipment intended to be arranged in a passenger compartment of the vehicle, notably seats on which passengers in the vehicle can sit, and/or
safety devices such as seat belts,
body elements, and/or
a shock-absorbing device, and/or
a wheelset, and/or
a protective casing.

More generally, the tank 2 may serve to retain any member or item of equipment on board the vehicle. In particular, the tank may support any item of equipment external to a storage system or to a system for distributing the energetic fluid. The tank may also serve to connect several bodywork elements to one another. Thus, it is also possible to envisage supporting on the tank 2 and fastening to the tank 2 the following: an electrochemical battery intended to supply a powertrain of the vehicle, and/or a powertrain, and/or transmission means between the powertrain and driven wheels, and/or wheel motors, and/or suspension means.

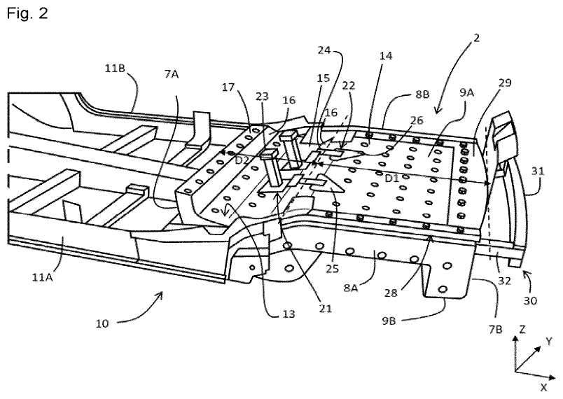

With reference to FIG. 2, the tank 2 may have a parallelepipedal overall shape. It may thus comprise three pairs of opposite walls. A first pair of opposite walls is made up of a front wall 7A and a rear wall 7B. The walls 7A and 7B extend substantially parallel to the axes Y and Z. A second pair of opposite walls is made up of a left lateral wall 8A and a right lateral wall 8B. The walls 8A and 8B extend substantially parallel to the axes X and Z. A third pair of opposite walls is made up of an upper wall 9A and a lower wall 9B. The walls 9A and 9B extend substantially parallel to the axes X and Y. As a variant, any other shape of the tank could be envisaged.

The tank 2 may be arranged in the rear part of the vehicle. In particular, the tank may form a rear part of the chassis 10 of the vehicle, that is to say a rear part of the underbody of the vehicle. The chassis 10 may comprise two side members 11A, 11B extending parallel to the axis X on either side of the vehicle. These two side members 11A, 11B may extend toward the rear only up to the front of a rear wheel arch of the vehicle, that is to say that the rear end of the side members 11A, 11B is positioned at the front of the rear wheels of the vehicle. The side members 11A, 11B may thus be shorter than on a conventional motor vehicle. The tank 2 is fastened directly to each of the two side members. By connecting the two side members 11A, 11B to one another, the tank 2 therefore acts as a crossmember of the vehicle. The tank 2 therefore makes it possible to keep the two side members rigidly in position with respect to one another. The use of the tank 2 therefore makes it possible to save on one or more crossmembers in the chassis 10. In any event, the vehicle 1 does not comprise a structural crossmember connecting two side members above or below the tank 2. The vehicle also does not comprise a structural crossmember at the rear of the tank 2 or directly in front of the tank 2.

The tank 2 extends toward the rear of the vehicle 1 in the longitudinal continuation of the two side members, that is to say that the rear end of the tank 2, notably the rear wall 7B, is positioned further rearward than the rear end of the side members 11A, 11B. The distance D1 along the longitudinal axis between the rear end of the side members 11A, 11B and a rear edge of the tank 2 may be, preferably, greater than or equal to 20 cm, or even greater than or equal to 40 cm, or even greater than or equal to 60 cm. The tank 2 may thus extend under a trunk of the vehicle, or even up to the region of a rear bumper of the vehicle. The tank may thus be intended to withstand the load exerted by all of the objects stowed in the trunk of the vehicle.

In order to ensure good fastening between the side members 11A, 11B and the tank 2, it is preferable to provide a longitudinal overlap between these components, that is to say that a front edge of the tank is positioned further forward than the rear end of the side members 11A, 11B. This avoids a hinge effect of the interface between the side members and the tank under the effect of a vertical load or in the event of a longitudinal impact. The distance D2 along the longitudinal axis between the rear end of the side members 11A, 11B and the front edge of the tank 2 may be, preferably, greater than or equal to 10 cm, or even greater than or equal to 20 cm, or even greater than or equal to 40 cm. In particular, the side members 11A, 11B preferably do not extend beyond half of the tank 2 along the longitudinal axis X. Each side member 11A, 11B may be fastened respectively to the two lateral walls 8A and 8B of the tank.

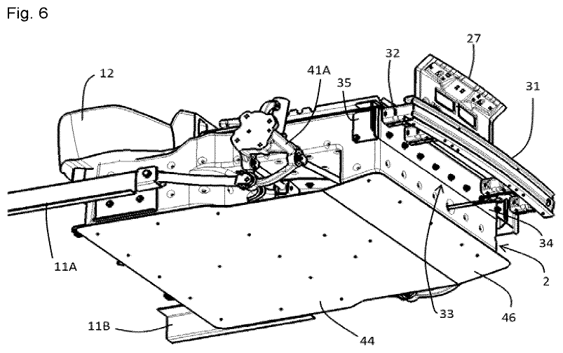

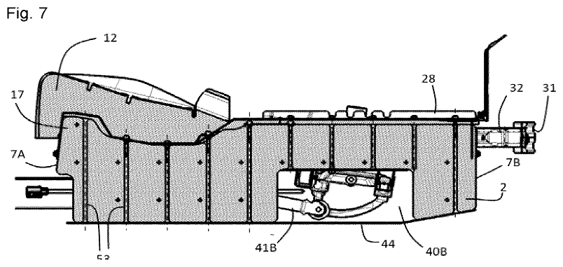

The tank 2 may extend substantially under the squab of seats 12 of the vehicle 1, notably rear seats. The seats 12 (the squab of which is visible in FIGS. 6 and 7) may without distinction be in the form of individual seats or in the form of a bench seat on which several people can sit side by side. The seats 12 may be supported by the tank and fastened to the tank. The seats 12 may be folding seats and rotation pin supports for the backrest of the seats may also be fastened to the tank 2.

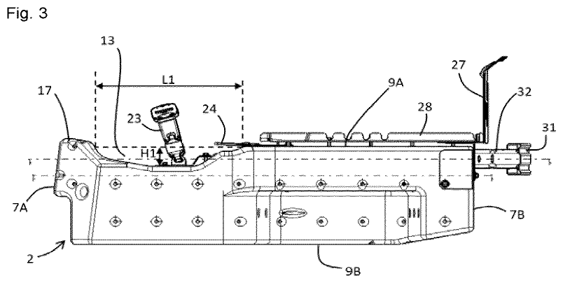

The upper wall 9A may comprise a recess 13 intended to receive the squab of the seats 12, in such a way that the passengers seated on these seats are not placed too high up. This recess 13 is notably clearly visible in FIG. 3. At the rear of the recess 13, the upper wall 9A comprises a horizontal plane 14. The horizontal plane 14 may be intended to form a trunk floor. The recess 13 extends to a lower height along the vertical axis Z than the horizontal plane 14 at the rear of the recess.

The recess 13 may have a profiled shape parallel to the transverse axis Y. The recess 13 may comprise a bottom 15, which is notably horizontal, flanked at the front and at the rear by inclined walls 16. The recess 13 may have a length L1 along the longitudinal axis X that corresponds substantially to the length of the squab of the seats 12 along this same axis, or at least 50% of the length of the squab of the seats 12. This length may be, for example, greater than or equal to 10 cm, preferably greater than or equal to 20 cm. The difference in height H1, along the vertical axis Z, between the bottom 15 of the recess 13 and the horizontal plane 14 at the rear of the recess may be, for example, greater than or equal to 5 cm, preferably greater than or equal to 10 cm. The height along the axis Z of the horizontal plane 14 at the rear of the recess 13 may be freely selected depending on a compromise between the stowage volume for the trunk and the capacity of the tank. The recess 13 may be arranged in a front half of the upper wall 9A, whereas the horizontal plane 14 may be arranged in a rear half of the upper wall 9A.

The chassis 10 does not comprise an additional structural element arranged between the tank 2 and the seats 12. The weight and the volume occupied by these components can thus be saved. A protective or separating partition may nevertheless be provided between the seats and the tank and/or between the trunk and the tank, notably in order to improve the esthetics and the comfort. However, this partition would not be intended to support the seats or objects transported in the trunk and its thickness could be reduced accordingly.

Advantageously, the tank 2 also comprises an anti-submarining device 17. Such a device forms a stop preventing the squab of the seats 12 from sliding forward in the event of an accident. The anti-submarining device 17 is formed by a protrusion extending forward and upward in front of the recess 13. The anti-submarining device 17 may have a profiled shape along the axis Y and/or extend over the entire width of the tank along the axis Y. As is clearly visible in FIG. 7, a lower face of the squab of the seat 12 may have a shape complementary to the shape of the anti-submarining device 17. The lower face of the squab of the seat 12 may therefore have a profiled hollow along the axis Y in which the protrusion of the anti-submarining device 17 is engaged. Besides the improvement in the safety of the passengers, the integration of the anti-submarining device 17 in the tank 2 makes it possible to increase the volume of the tank and therefore to increase its energetic fluid storage capacity.

The tank 2 also provides a support for the fastening of a safety device. The safety device aims to protect the passengers in the vehicle in the event of an accident. In particular, the safety device may comprise a seat belt and/or a device according to standard ISO 13216-1:1999, more commonly called an isofix system. In particular, an anchoring means 21 for a seat belt and/or an anchoring means 22 according to standard ISO 13216-1:1999 may be fastened to an upper wall 9A of the tank. The anchoring means 21, 22 may be fastened, for example welded or screwed, to a plate, which is itself screwed against the tank 2.

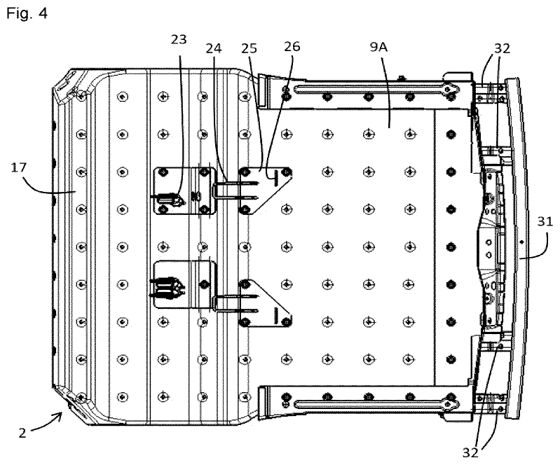

Thus, the tank 2 is intended to withstand significant tensile forces exerted by the anchoring means in the event of an accident. The anchoring means 21 may be connected to a clip-fastening device 23 of a seat belt, also called a buckle. Such a clip-fastening device 23 projects between the squab and a backrest of the seat 12 positioned above the tank and it is intended to be actuated by a passenger in order to lock or unlock the seat belt. As an alternative, the anchoring means 21 could also be connected to a seat belt turning loop, and/or to a seat belt retractor, and/or to a seat belt blocking device. As is clearly visible in FIGS. 3 and 4, the anchoring means 21 may be fastened to the bottom 15 of the recess 13.

The anchoring means 22 may comprise a hoop 24, which is notably metallic and/or in the shape of a U. This hoop 24 is intended to cooperate with a fastening device integrated in a removable seat, for example an infant seat, in order to firmly retain this removable seat. The hoop 24 may extend horizontally in line with the recess 13. In particular, the hoop 24 may be welded to a plate 25 which is itself screwed in the tank at a front edge of the horizontal plane 14.

Advantageously, one or more securing hooks 26 for securing baggage may also be fastened to the tank 2. The securing hooks 26 may be fastened against the horizontal plane 14 situated at the rear of the recess 13. As is visible in FIG. 4, a securing hook 26 may possibly be fastened, notably welded, to the plate 25 to which the hoop 24 is welded. As an alternative, the securing hook 26 may be fastened, notably welded, to a separate plate.

The tank 2 also supports a rear part of the body. This rear part of the body may comprise, for example, pillars extending substantially vertically up to a roof of the vehicle, and/or rear fenders or quarter panels, and/or a rear part of a rear door surround of the vehicle, and/or a trunk hatch or door of the vehicle and a surround of such a hatch. The part of the vehicle body supported by the tank 2 may be fastened to the tank, notably in a rear half of the upper wall 9A of the tank. To this end, the chassis 10 comprises a frame 28 fastened directly to the tank 2. The frame 28 may itself be fastened directly to a part of the vehicle body or even constitute a lower edge of the body. The frame 28 may be arranged along a perimeter of the upper wall 9A of the tank. It may have the overall shape of a U. The frame 28 may notably comprise a first segment extending along a rear edge of the tank 2 and a second and a third segment extending along the lateral edges of the tank. The frame 28 may be provided from metallic material and/or have an angle iron shape. The frame 28 may notably comprise a wall 29 extending against the upper wall 9A of the tank. Said wall 29 may be fastened to the tank by fastening means such as fastening screws. The number and/or the arrangement of the fastening screws can be freely selected in order to obtain the desired rigidity and the desired retention. In particular, the fastening screws may be distributed at a regular spacing, for example a spacing of between 5 cm and 30 cm inclusive, notably between 10 cm and 20 cm inclusive.

A trunk bottom 27 is fastened directly to the tank 2 or is fastened to the tank 2 by way of the frame 28. The trunk bottom 27 comprises a rear wall of the trunk which extends transversely and vertically under the trunk door in the closed position. Means for locking the trunk door, such as a striker wire, may also be fastened to the trunk bottom 27.

The vehicle 1 further comprises a shock-absorbing device 30 supported by the tank 2 and fastened to the tank 2. In particular, the shock-absorbing device 30 is fastened exclusively to the tank 2. The shock-absorbing device 30 is therefore not fastened to the side members of the vehicle, nor to a metallic crossmember.

The shock-absorbing device 30 is intended to absorb all or some of the kinematic energy transferred to the vehicle 1 in the event of an impact against the shock-absorbing device 30. The shock-absorbing device 30 may thus be integrated in a bumper of the vehicle. The shock-absorbing device 30 may be covered by a trim part of the vehicle.

According to the embodiment presented, the shock-absorbing device 30 is arranged so as to withstand longitudinal impacts on the rear of the vehicle. It is therefore integrated in a rear bumper of the vehicle. As a variant, the shock-absorbing device 30 could be arranged so as to withstand longitudinal impacts on the front of the vehicle and therefore be integrated in a front bumper.

When an impact occurs against the shock-absorbing device 30, a force is automatically transmitted to the tank 2. The high strength and high robustness of said tank allow it to withstand this force without damage or deformation. The force of the impact is then transmitted to the side members 11A, 11B extending further to the front of the tank 2. The tank 2 therefore acts as an intermediate part between the shock-absorbing device 30 and the side members 11A, 11B. In other words, the shock-absorbing device 30 is connected to the side members by way of the tank 2.

The shock-absorbing device 30 comprises a rear impact crossmember 31, a set of columns 32 intended to deform in the event of an impact, and a support 33 intended to be fastened directly against the tank 2. The rear impact crossmember 31 is fastened to the tank by way of the columns 32 and the support 33. The columns may be referred to as “programmed deformation” columns, that is to say that they may be designed to deform in a predictable manner in the event of an impact against the rear impact crossmember 31 so as to optimize the quantity of energy absorbed by the deformation and/or so as to better control the deformation modes of the shock-absorbing device 30. To this end, the columns may comprise points of weakness such as openings or notches.

The rear impact crossmember 31 may extend at least roughly parallel to the transverse axis Y, at the rear of the tank 2. The columns may extend parallel to the longitudinal axis X between the rear impact crossmember 31 and the rear wall 7B of the tank. The columns 32 thus comprise a first end fastened, for example welded, to the support 33 and a second end fastened, for example welded, to the rear impact crossmember 31. The columns may have a square section, a rectangular section or a section of any other shape.

According to one embodiment variant, the columns 32 could also extend obliquely with respect to the longitudinal axis X. The axis along which the columns extend could, for example, form an angle of between 0° and 30° with the longitudinal axis X, or even an angle of between 0° and 45°.

According to one embodiment, the rear impact crossmember 31 could be fastened to the support 33 by way of a single column 32. This single column would preferably be positioned at the center of the shock-absorbing device 30. Preferably, the rear impact crossmember 31 is fastened to the support 33 by way of at least two columns 32, or even at least three columns 32, or even at least four columns 32. These columns 32 may be distributed over the width of the tank 2, along the transverse axis Y. FIG. 2 illustrates a shock-absorbing device comprising two columns 32, whereas FIGS. 3, 4 and 5 illustrate a shock-absorbing device comprising four columns 32. There can be any number of columns. Preferably, the columns are spaced apart so as to not interfere with one another when they deform following an impact.

Since the tank 2 provides a wide rear wall 7B, a large surface area for the fastening of the shock-absorbing device 30 is available. It is thus possible to more easily increase the number of columns supporting the rear impact crossmember 31, thus increasing the energy absorption capacity of the shock-absorbing device 30. The invention thus enables a significant gain with respect to the vehicles equipped with a rear impact crossmember 31 fastened to the side members of the vehicle. Specifically, in such vehicles, only two columns facing each side member are provided, thus reducing the energy absorption capacity.

According to one embodiment, a honeycomb structure could be provided between the rear wall 7B of the tank and the rear impact crossmember 31, as a replacement for or in addition to the columns 32.

Since the crossmember can be supported by a larger number of columns and/or by a honeycomb structure, the design of the rear impact crossmember 31 can be simplified. The rear impact crossmember 31 may, for example, have a simple rectilinear shape parallel to the transverse axis Y, that is to say a non-curved shape. The section of the rear impact crossmember 31 may, for example, have a U shape. A crossmember in the form of a circular arc centered about an axis parallel to the vertical axis Z is nevertheless also possible.

The support 33 may comprise a main plate 34 extending parallel to the transverse axis Y and to the vertical axis Z. This main plate 34 is fastened to the rear wall 7B of the tank, notably screwed by means of a set of fastening screws passing through holes provided in this plate. Since the main plate 34 is supported by the rear wall 7B, the main plate 34 may be relatively thin. The main plate 34 may have, for example, a thickness less than or equal to 2 mm. The main plate is not intended to further stiffen the tank. It may only serve to distribute the pressure exerted by the columns over a larger surface area in the event of an impact. It is therefore not a crossmember of the chassis.

The support 33 may also comprise auxiliary plates 35 perpendicular to the main plate 34. According to the embodiment presented, the auxiliary plates 35 extend parallel to the longitudinal axis X and to the vertical axis Z and are fastened respectively to the lateral walls 8A and 8B of the tank, notably by means of fastening screws. The fastening of the shock-absorbing device 30 by the lateral plates 35 in addition to the fastening by the main plate 34 improves the holding of the shock-absorbing device.

According to one embodiment variant, the support 33 could comprise only a single auxiliary plate. According to another embodiment variant, the support 33 could comprise an auxiliary plate extending parallel to the longitudinal axis X and to the transverse axis Y, and fastened to the upper wall 9A. The support 33 could also comprise an auxiliary plate extending parallel to the longitudinal axis X and to the transverse axis Y, and fastened to the lower wall 9B.

In the event of an impact on the rear of the vehicle, the columns 32 deform and absorb the energy of the impact. In particular, the columns 32 compress between the crossmember 31 and the main plate 34, which bears against the rear wall of the tank. The shock wave is transmitted to the side members 11A, 11B by way of the tank 2. The tank comprises a structure 6 that is non-deformable or virtually non-deformable. It thus transmits all of the forces received to the side members 11A, 11B. If the impact is moderate, only the columns are deformed. The operations for repairing the vehicle are particularly simple because it suffices to unscrew the shock-absorbing device 30 from the tank 2 and to replace it with a new shock-absorbing device 30.

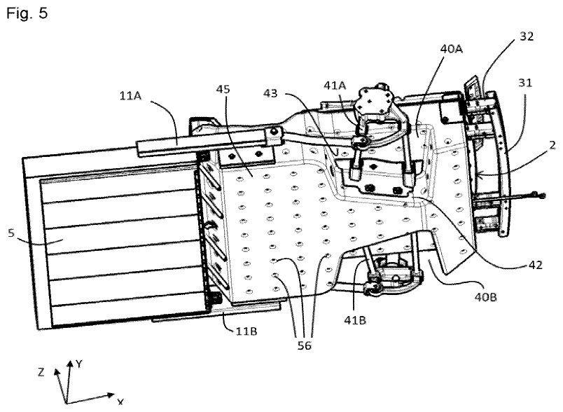

FIG. 5 illustrates the chassis 10 of the vehicle in a view from below. It is observed that the tank 2 may comprise two cavities 40A, 40B intended to receive elements 41A, 41B of a wheelset of the vehicle 1. These cavities 40A, 40B are open toward the bottom and each toward a lateral side of the tank. They may be delimited by a set of vertical walls 42 and by a horizontal wall 43 extending to the mid-height of the tank. By providing the cavities 40A, 40B in the tank 2, the lower wall 9B of the tank can be particularly close to the ground outside these cavities. The lower wall 9B thus comprises a zone 45 (substantially in the shape of an H according to the embodiment presented in FIG. 5) which extends horizontally lower down than the elements 41A, 41B of the wheelset. It is thus possible to increase the capacity of the tank and to lower the center of gravity of the vehicle, thus improving its stability.

Advantageously, the vehicle 1 does not comprise a load-bearing structure for supporting the tank 2 from below. By virtue of its high strength, the tank 2 can be exposed to impacts occurring beneath the vehicle, for example an impact produced by a stone being thrown up or an impact caused by the mounting of a curb. Nevertheless, as will be set out below, it is possible to fasten a protective casing under the tank 2 so as to provide additional protection.

Advantageously, and as illustrated in FIGS. 6 and 7, the vehicle therefore comprises a protective casing 44 fastened to the tank 2. The protective casing 44 extends horizontally under the tank 2. It may be fastened directly to the tank 2, without an intermediate part. The protective casing 44 has an upper face facing the lower wall 9B of the tank, and a lower wall exposed to objects being thrown up from the road. Thus, the lower wall 9B is protected from impacts caused by stones being thrown up or when mounting curbs.

Advantageously, the protective casing 44 closes the cavities 40A, 40B from below. In other words, the cavities 40A, 40B are delimited from below by portions of the protective casing 44. The protective casing 44 thus protects the elements 41A, 41B of the wheelset.

The protective casing 44 is preferably a monobloc element, that is to say a single-piece element. The protective casing 44 thus provides better protection against water spray compared with the protective casing formed of several elements assembled together. It may have a rectangular overall shape. Preferably, the protective casing 44 extends under the entire lower wall of the tank 2. The protective casing 44 therefore extends over the entire width of the underbody of the vehicle along the transverse axis Y, up to the vicinity of the wheels that are connected to the elements 41A, 41B of the wheelset of the vehicle.

The protective casing makes it possible to propose a vehicle with a flat bottom. A flat bottom improves the aerodynamics of the vehicle and reduces the risk of elements external to the vehicle catching on the lower face of the protective casing.

The protective casing 44 may be made of plastic, of metal or of any other material. It may comprise several materials, notably to improve its acoustic insulation performance.

According to one embodiment, the protective casing 44 may comprise a deflector 46 configured to create a ground effect through air circulation. The ground effect is an aerodynamic effect which is intended to press the vehicle toward the ground and which therefore makes it possible to improve its grip on the ground. The deflector 46 may comprise a surface that is inclined slightly with respect to the longitudinal axis X. This inclined surface may extend rearward and upward in the rear part of the protective casing 44. As an alternative or in addition, the protective casing 44, and notably the deflector 46, may also comprise downwardly projecting fins that extend in a plane parallel to the longitudinal axis X and to the vertical axis Z. Such fins improve the lateral stability of the vehicle.

The protective casing 44 may be exclusively fastened to the tank. As an alternative, the vehicle may comprise a rear bumper element positioned at the rear of the protective casing 44. The protective casing 44 may be fastened to this rear bumper element. An overlap between the rear bumper element and the protective casing may be provided in order to improve the protection.

Advantageously, the vehicle 1 may also comprise an acoustic filtration element interposed between the protective casing 44 and the lower wall 9B of the tank. The acoustic filtration element improves the sound insulation for the passenger compartment, which is particularly useful when the vehicle comprises an electric powertrain since such a powertrain is very quiet in operation. The acoustic filtration element may, for example, comprise a felt and/or foam layer.

With reference to FIG. 5, it is also observed that the electrochemical battery 5 extends at the front of the tank 2 along the longitudinal axis X. The electrochemical battery 5 notably extends between the two side members 11A, 11B and is fastened to the two side members 11A, 11B. The electrochemical battery 5 comprises a lower wall facing toward the ground. The vehicle may comprise a second protective casing (not shown) configured to protect the lower wall of the electrochemical battery. The protective casing 44 may be fastened to the second protective casing. An overlap between the protective casing 44 and the second protective casing may also be provided in order to improve the protection.

Advantageously, the structure 6 of the tank 2 is made of composite material. Such a material is more lightweight than steel and even than any other metal for an equivalent strength. In addition, the methods for manufacturing components made of composite material make it possible to produce structures 6 with a wide variety of geometric shapes. Shapes of the structure 6 that are more complex than those obtained from metal can thus be envisaged so as to utilize all the available volume in the vehicle and thus increase the capacity of the tank. More complex tank shapes may in particular be recommended when the tanks are intended to store a pressurized gas rather than a liquid because, contrary to a liquid, the gas does not have the risk of being retained in the tank.

The composite material may comprise a layered or preformed structure, and/or braided materials impregnated with resin. The composite material may be constructed on the basis of reinforcing elements and a matrix. The reinforcing elements may comprise carbon or glass fibers, which are lightweight materials, or Kevlar (registered trademark) which has a greater impact resistance. The matrix may be an organic matrix, for example epoxy resin, phenolic resin or a modified polyester. The matrix may also be a metal matrix.

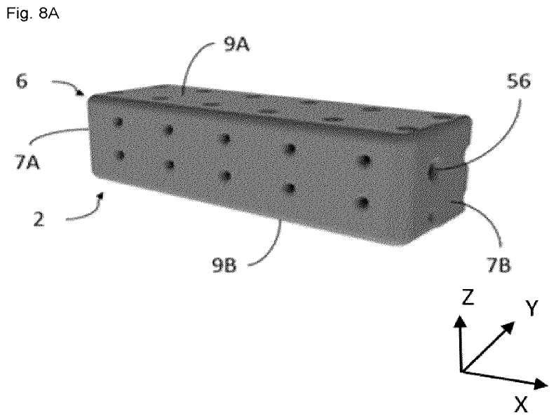

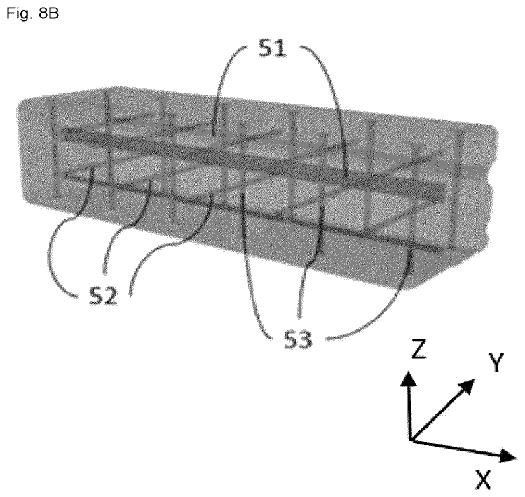

FIGS. 8A and 8B illustrate perspective views of the structure 6 of one embodiment of the tank 2. The walls 7A and 7B are connected to one another by a first set of connecting elements 51 extending parallel to the axis X. Likewise, the walls 8A and 8B are connected to one another by a second set of connecting elements 52 extending parallel to the axis Y and the walls 9A and 9B are connected to one another by a third set of connecting elements 53 extending parallel to the axis Z.

According to one embodiment variant, the tank 2 could comprise only a single set of connecting elements or only two sets of connecting elements from among the three sets of connecting elements 51, 52, 53. As a variant, all or some of the sets of connecting elements 51, 52, 53 could extend in directions different from the axes X, Y and Z, provided that the axis along which each of the sets of connecting elements extends forms a non-zero angle with the axis along which the other sets of connecting elements extend. Advantageously, the three axes along which the three sets of connecting elements 51, 52 and 53 extend are perpendicular to one another so as to optimally stiffen the tank.

The connecting elements 51, 52, 53 pass right through the tank 2 between two opposite walls. The connecting elements act as tie rods enhancing the strength of the tank: they are subjected to tensile loading when the energetic fluid contained in the tank exerts a pressure on the walls 7A, 7B, 8A, 8B, 9A and 9B. The connecting elements 51, 52, 53 are arranged inside the shell of the tank 2 and not at the periphery of this shell.

Preferably, each connecting element is separate from the other connecting elements, that is to say that the connecting elements are not in contact with one another do not touch inside the tank. Thus, the tank 2 is not compartmented and the energetic fluid can circulate easily inside the tank 2.

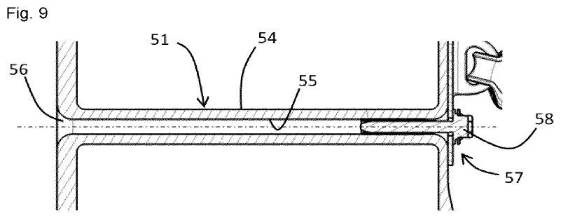

The connecting elements 51, 52, 53 are hollow. Notably, the connecting elements, which could also be called “reinforcement wells”, may be tubes when they have a circular section. However, the section of the connecting elements is not necessarily circular. For example, the section of the connecting elements could also be square, rectangular, polygonal or oval. FIG. 9 illustrates in more detail one connecting element 51, the other connecting elements being designed analogously. Each connecting element 51, 52, 53 has a tubular shape provided with an outer face 54 and an inner face 55. The outer face 54 faces toward the inside of the tank and is therefore intended to be in contact with the energetic fluid, whereas the inner face 55 communicates with the outside of the tank and is therefore intended to be in contact with the ambient air.

The connecting elements 51, 52, 53 may consist of composite material or metal. They may also comprise both a composite material and metal. They may notably comprise a metallic tube arranged inside a composite material structure.

The inner face 55 may be provided from a material different from the one forming the structure 6 of the tank. The inner face 55 may notably be equipped with a metallic tube which extends over the entire length of the connecting element 51, 52, 53 or only at the ends of the connecting elements 51, 52, 53. The metallic tube may possibly be corrugated along its outer perimeter so as to ensure good retention in the structure 6.

Each connecting element 51, 52, 53 comprises two opposite ends at the two opposite walls it connects. Due to the hollow character of the connecting elements, the tank comprises, for each connecting element, an opening 56 passing right through the tank. These openings 56 do not communicate with the volume for storing energetic fluid. These openings 56 are therefore not useful for delivering an energetic fluid, notably for delivering pressurized hydrogen to the fuel cell 3.

On the other hand, the openings 56 may be used for the passage of electrical wires and/or hydraulic lines. It is thus possible to save on the space provided outside the tank for the passage of these electrical wires and/or these hydraulic lines while offering them a means for being held in position.

The openings 56 may also be used to allow a liquid to be discharged from the vehicle, or even to carry out ventilation operations aiming to cool or heat the passenger compartment.

Advantageously, and as explained below, the openings 56 may be used to fasten different items of equipment of the vehicle. In particular, the openings 56 are used to fasten the seats 12, the anchoring means 21, 22 of the safety devices, the body frame 28, the shock-absorbing device 30, the elements 41A, 41B of the wheelsets, and the protective casing 44 as described above.

To this end, the tank 2 comprises a set of fastening interfaces 57, each arranged at an end of at least one connecting element 51, 52, 53, notably arranged in an end of an opening 56. As illustrated in FIG. 9, all or some of the fastening interfaces 57 may comprise an insert intended to cooperate with a fastening screw 58, for example a fastening screw of the M8 or M10 type. The insert may be formed in the metallic tube equipping the inner face 55 of the connecting elements or be an additional element fitted against the inner face 55 of the connecting elements, for example a plastics pin. The insert may, for example, have a length of between 20 mm and 60 mm inclusive. The insert may be threaded or non-threaded. The insert thus provides a fastening means extending deeply into the volume of the tank. Such a fastening means is particularly robust and makes it possible to envisage the fastening of significant loads.

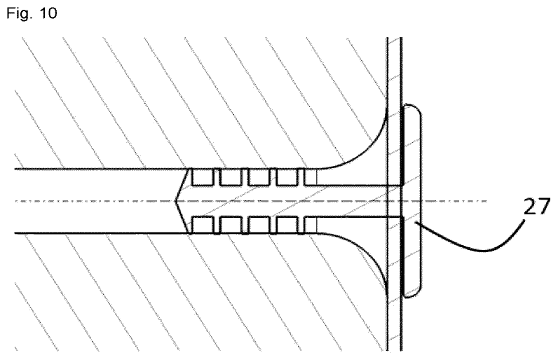

As illustrated in FIG. 10, all or some of the fastening interfaces 57 may comprise an insert intended to cooperate with a clip 59. The clip 59 may comprise radial fins in interfering engagement with the tubular insert and be force-fitted into this insert. As a variant, the clip 59 could have any other shape. It could for example be intended to be force-fitted and to be unscrewed in order to be removed. In addition, adhesive or mastic may be applied in an opening 56 in order to improve the holding of the fastening screw 58 or of the clip 59. The use of clips 59 may be preferred to the use of fastening screws in order to fasten items of equipment having a moderate mass and other than safety devices, for example in order to fasten the protective casing 44.

Each fastening interface 57 makes it possible to fasten an item of equipment of the vehicle against a wall of the tank. A fastening interface 57 may be arranged at the end of the opening 56 situated on the side of the wall against which the item of equipment is fastened. As an alternative, a fastening interface 57 could also be arranged at the end of the opening 56 situated on the opposite side from the wall against which the item of equipment is fastened. In this case, a shaft or a cable connecting the fastening interface 57 to the item of equipment could extend inside the opening 56 along the latter. Such an arrangement would for example make it possible to provide fastening interfaces at the lower wall 9B in order to fasten items of equipment against the upper wall 9A, which would facilitate the vehicle assembly or maintenance operations.

Preferably, one or more fastening interfaces arranged on the lateral walls 8A and 8B are used to respectively fasten the side members 11A and 11B. One or more fastening interfaces arranged on the upper wall 9A are used to fasten the seat 12 and/or the anchoring means 21, 22 and/or the body frame 28. One or more fastening interfaces arranged on the rear wall 7B are used to fasten the shock-absorbing device 30. One or more fastening interfaces arranged on the lower wall 9B are used to fasten the protective casing 44.

Advantageously, such fastening interfaces 57 may be provided at the ends of each opening 56 in the tank. Each connecting element 51, 52, 53 may thus support two fastening interfaces 57 arranged on two opposite faces of the tank. The tank may thus be provided with a multiplicity of fastening interfaces 57 for fastening various items of equipment in very different positions.

The same item of equipment may even be fastened to the tank 2 using two fastening interfaces or even more, so as to properly secure its fastening. The same item of equipment may also easily be fastened in different positions of the tank, without needing to be modified.

The same tank 2 may also be easily reused for different vehicle models because the multiplicity of fastening interfaces provide numerous possibilities for fastening items of equipment.

The openings 56 that are not intended to fasten an item of equipment of the vehicle may be plugged with a shut-off means so as to prevent the accumulation of mud, sand, dirt, stones or any other particles. In particular, the unused openings 56 may be shut off with individual plugs or with a film surrounding the entire tank or any other protective device. The unused openings 56 may possibly be used over the life of the vehicle, for example in order to fasten a new item of equipment or a new accessory. In the context of a maintenance operation, it is possible to envisage removing an item of equipment, for example the shock-absorbing device 30, and replacing it with a new item of equipment which would be fastened using fastening interfaces that up to then were unused.

Advantageously, the connecting elements 51, 52, 53 are distributed at a regular spacing, for example a spacing of between 5 cm and 30 cm inclusive, notably between 10 cm and 20 cm inclusive. Consequently, the fastening interfaces 57 are distributed on the walls of the tank at a regular spacing. The fastening interfaces 57 are thus arranged in a grid pattern on the surface of the tank 2. This also facilitates the reuse of the same tank and of the same item of equipment for different vehicle models because this same item of equipment can be fastened at several locations of the tank without requiring an adaptation part. The tank thus forms a modular structure, like a Lego® brick, to which numerous items of equipment can be fastened. The invention therefore makes it possible to envisage a large degree of design freedom for motor vehicles while realizing economies of scale.

To manufacture the vehicle 1, it is possible to first of all manufacture a chassis by notably assembling the tank 2 with the side members 11A, 11B. Different items of equipment of the vehicle can then be fastened to the tank 2. In particular, the seats 12, the anchoring means 21, 22 of the safety devices, the body frame 28, the shock-absorbing device 30, the elements 41A, 41B of the wheelsets, and the protective casing 44 as described above are fastened to the tank 2 by means of the fastening interfaces 57. The assembly of the tank therefore occurs before the fastening of these various items of equipment in the method for manufacturing the vehicle. The fastening of these various items of equipment may be effected simply by screwing of fastening screws 58 or by fitting of clips 59. The maintenance operations requiring the removal of these items of equipment are also facilitated.

Finally, by virtue of the invention, a vehicle equipped with a tank for an energetic fluid that is more lightweight is obtained because a part of the metallic chassis with which vehicles are usually provided is saved. The vehicle also offers more space for passengers or for stowage because the tank occupies a part of the volume that was previously occupied by the chassis. As an alternative, this available volume may also be utilized to increase the size of the tank and therefore to propose a vehicle with a greater autonomy. Lastly, the tank provides a particularly practical support for fastening a wide variety of items of equipment on board the vehicle.

1-10. (canceled)

11. A chassis for a vehicle, comprising:
a first side member;
a second side member; and
a tank configured to store an energetic fluid,
wherein the side members extend parallel to a longitudinal axis, the tank is arranged in a continuation of the side members along the longitudinal axis and fastened to the side members, and the tank is configured to withstand a load exerted by at least one item of equipment on board the vehicle and/or by body elements of the vehicle.

12. The chassis as claimed in claim 11, wherein the side members are fastened respectively against two opposite lateral walls of the tank.

13. The chassis as claimed in claim 11, wherein the tank comprises an upper wall provided with a recess configured to receive a squab of at least one seat of the vehicle.

14. The chassis as claimed in claim 11, wherein the tank comprises an anti-submarining device configured to prevent a squab of a seat of the vehicle from sliding forward in an accident.

15. An arrangement for a vehicle, comprising:
the chassis as claimed in claim 11, and
at least one item of equipment and/or body elements supported by the tank and fastened to the tank.

16. The arrangement as claimed in claim 15, wherein the at least one item of equipment is supported by the tank and fastened to the tank, the at least one item of equipment comprising at least one seat of the vehicle and/or a safety device configured to safeguard a passenger in an accident.

17. The arrangement as claimed in claim 15, further comprising:
anchoring means for a seat belt, fastened to an upper wall of the tank, and/or
anchoring means according to standard ISO 13216-1:1999 fastened to an upper wall of the tank.

18. The arrangement as claimed in claim 17, wherein the upper wall of the tank is provided with a recess configured to receive a squab of at least one seat of the vehicle, and wherein:
the fastened anchoring means for the seat belt is fastened to a bottom of the recess, and/or
the anchoring means according to standard ISO 13216-1:1999 comprises a hoop extending horizontally in line with the recess.

19. The arrangement as claimed in claim 15, further comprising:
body elements supported by the tank and fastened to a rear half of the tank, the side members being fastened to a front half of the tank.

20. A motor vehicle, comprising:
the chassis as claimed in claim 11.

21. A motor vehicle, comprising:
the arrangement as claimed in claim 15.
